(19) United States
(12) Patent Application Publication
(10) Pub. No.: US 2014/0231603 A1
(43) Pub. Date: Aug. 21, 2014

(54) Culinary Appliance

(71) Applicant: Buddie by RDH, LLC, Greenville, SC (US)

(72) Inventors: Derrick M. Holland, Greenville, SC (US); Ryan D. Holland, Greenville, SC (US)

(73) Assignee: Buddie by RDH, LLC, Greenville, SC (US)

(21) Appl. No.: 14/177,383

(22) Filed: Feb. 11, 2014

Related U.S. Application Data
(60) Provisional application No. 61/763,155, filed on Feb. 11, 2013.

(51) Int. Cl. F16M 11/04

(52) U.S. Cl. CPC F16M 11/04
USPC 248/176.1; 29/428

(57) ABSTRACT

A culinary appliance comprising attachable and detachable components may be in the shape of a person, icon, avatar, animal, an inanimate item, a product, or the like, or any appropriate combination thereof. The detachable components may comprise utensils, wares, or the like. For example, the culinary appliance may be formed in the likeness of a person and appendages of the person may comprise cooking utensils, measuring utensils, and/or bowls.

### CROSS REFERENCE TO RELATED APPLICATIONS

The instant application claims priority to U.S. provisional patent application No. 61/763,155, filed Feb. 11, 2013. U.S. provisional patent application No. 61/763,155 is incorporated by reference herein in its entirety.

### TECHNICAL FIELD

The technical field generally relates to a culinary appliance and more specifically relates to a culinary appliance comprising detachable components.

### BACKGROUND

When working in a kitchen, it is not uncommon to search for a utensil, bowl, or the like. At times, the search may interfere with meal preparation, especially if the item being searched for cannot readily be found. One could lay out all utensils and wares on a table top or the like in attempt to keep items within reach. Not only would this be aesthetically unappealing, but it would occupy valuable space that may be needed for culinary activities.

### SUMMARY

The following presents a simplified summary that describes some aspects or embodiments of the subject disclosure. This summary is not an extensive overview of the disclosure. Indeed, additional or alternative embodiments of the subject disclosure may be available beyond those described in the summary.

A culinary appliance, also referred to as a culinary apparatus herein, may be in the shape of a person, icon, avatar, an inanimate item, or the like, or any appropriate combination thereof The culinary appliance may comprise multiple sites to which components may be attached and from which components may be detached. The attachable and detachable components may comprise utensils, wares, or the like. Components may be attached and detached from a skeletal dock of the culinary apparatus without detrimentally affecting the use of any component. The appliance may be formed in the likeness of a person and appendages of the person may comprise cooking utensils, measuring utensils, and/or bowls, or the like.

### BRIEF DESCRIPTION OF THE DRAWINGS

Reference is made here to the accompanying drawings, which are not necessarily drawn to scale.

FIG. 1 is an illustration of an example culinary apparatus comprising a docking component and detachable components.

FIG. 2 is another illustration of an example culinary apparatus.

FIG. 3 is an example illustration of the skeletal dock of the culinary apparatus comprising example fasteners.

FIG. 4 is another example illustration of the skeletal dock of the culinary apparatus.

FIG. 5 is an illustration of an example component resembling a foot comprising multiple measuring cavities.

FIG. 6 is a more detailed illustration of an example component resembling a foot comprising multiple measuring cavities.

FIG. 7 is another example depiction of the culinary apparatus described herein.

FIG. 8 is another example depiction of the culinary apparatus wherein components are detached.

### DETAILED DESCRIPTION OF ILLUSTRATIVE EMBODIMENTS

Aspects of the instant disclosure are described more fully herein with reference to the accompanying drawings, in which example embodiments are shown. In the following description, for purposes of explanation, numerous specific details are set forth in order to provide an understanding of the various embodiments. However, the instant disclosure may be embodied in many different forms and should not be construed as limited to the example embodiments set forth herein. Like numbers refer to like elements throughout.

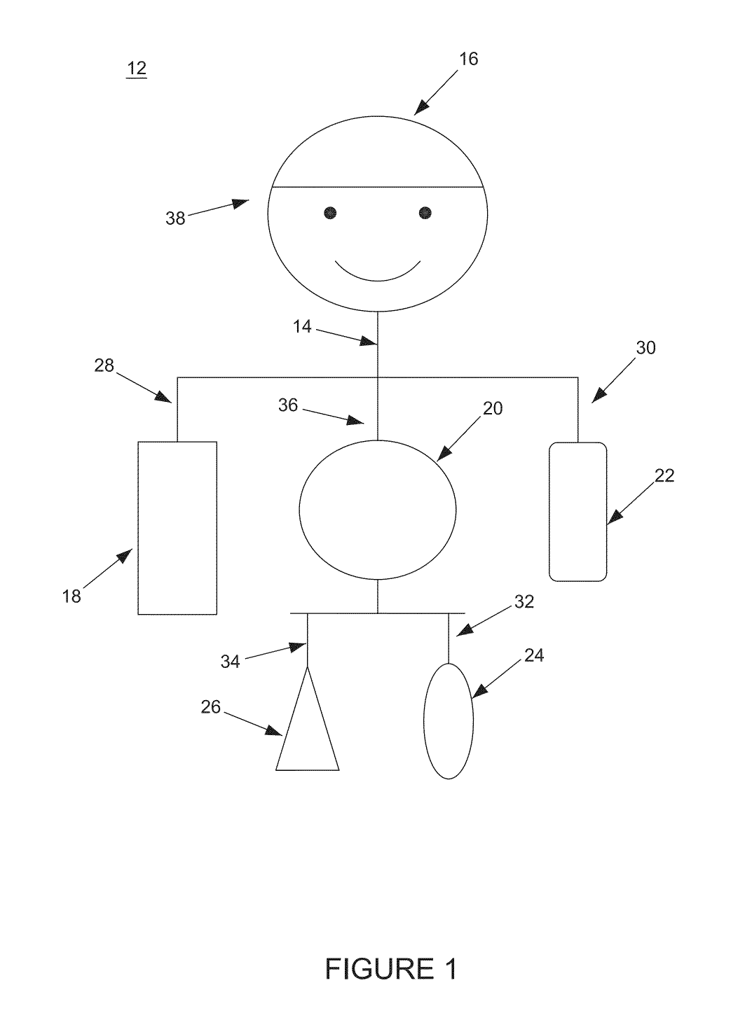

FIG. 1 is an illustration of an example culinary apparatus 12 comprising a skeletal-like docking component (also referred to herein as a skeletal dock) 14 and detachable components 16, 18, 20, 22, 24, 26. The skeletal dock 14 may comprise multiple sites at which components may be attached and/or detached. As depicted in FIG. 1, component 16 may be attached to the skeletal dock 14 at site 38, component 18 may be attached to the skeletal dock 14 at site 28, component 20 may be attached to the skeletal dock 14 at site 36, component 22 may be attached to the skeletal dock 14 at site 30, component 24 may be attached to the skeletal dock 14 at site 32, and component 26 may be attached to the skeletal dock 14 at site 34.

In an example embodiment, each of the components may be attached to any site. And each of the components may be detached from any site. For example, each of components 16, 18, 20, 22, 24, 26 may be attached to and/or detached from each of sites 28, 30, 32, 34, 36.

In an example embodiment, the skeletal dock 14 may comprise a site, or sites, that are configured to be attached to and/or detached from, a subset of components. For example, as depicted in FIG. 1, site 38 may be configured to be attached to and/or detached from components such as bowls, cups, measuring cups, colanders, or the like. In various example embodiments, a component may comprise a site for another component to be attached to and/or detached from.

It is to be understood that the culinary apparatus depicted herein is merely an example, and that the configuration depicted therein is not to be limited thereto. Thus, although the culinary apparatus 12 may resemble a person, and the skeletal dock 14 of the culinary apparatus 12 may resemble a skeleton or frame of a person, the resemblance should not be limited thereto. The culinary apparatus may resemblance any appropriate item. Examples items may include a person, a character, an icon, an animal, a pet, an avatar, an inanimate item, a product, or the like, or any appropriate combination thereof It is also to be understood that the number of components may vary, the nature of the components may vary, the configuration of the skeletal dock may vary, locations of sites at which components may be attached and/or detached may vary, and the configuration of sites may vary.

A component may comprise any appropriate component. In an example embodiment, a component may comprise any appropriate culinary utensil. For example, a component may comprise a bowl, a cup, a colander, a baster, a brush, a whisk, a roller, a rolling pin, a sieve, a spatula, a spoon, a knife, a fork, a dish, measuring jug, measuring cup, a measuring device, measuring spoon, a dispense (e.g., salt shaker, pepper shaker), a corer (e.g., apple corer), a cutter (e.g., cookie cutter, apple cutter), a basket, a press, a lid, a jar, a pan, a pot, a tray, a butter curler, a block (e.g., cutting block), a server (e.g., cake server, pie server), a scoop, a pitter (e.g., a cherry pitter), a strainer, a corkscrew, a cracker (e.g., nut cracker, seafood cracker), scraper, a poacher (e.g., egg poacher), a timer, a sifter, a funnel, a grater, a ladle, a reamer (e.g., lemon reamer), a juicer (e.g., lemon squeezer), a mandolin, a grinder, a thermometer, a melon baller, a mortar, a pestle, a tin (e.g., cupcake tin, muffin tin), a pot holder, an oven glove, a bag (e.g., pastry bag), a blender (e.g., pastry blender), a masher (e.g., potato masher), a mixer, a wheel (e.g., pizza cutter, pastry cutter), a peeler (e.g., potato peeler), a peel (e.g., pizza shovel), a mill (e.g., pepper mill, salt mill), a press (e.g., garlic press), shears, scissors, a scale, a scoop, a skimmer, a opener (e.g., can opener), tongs, a zester, or the like, or any appropriate combination thereof.

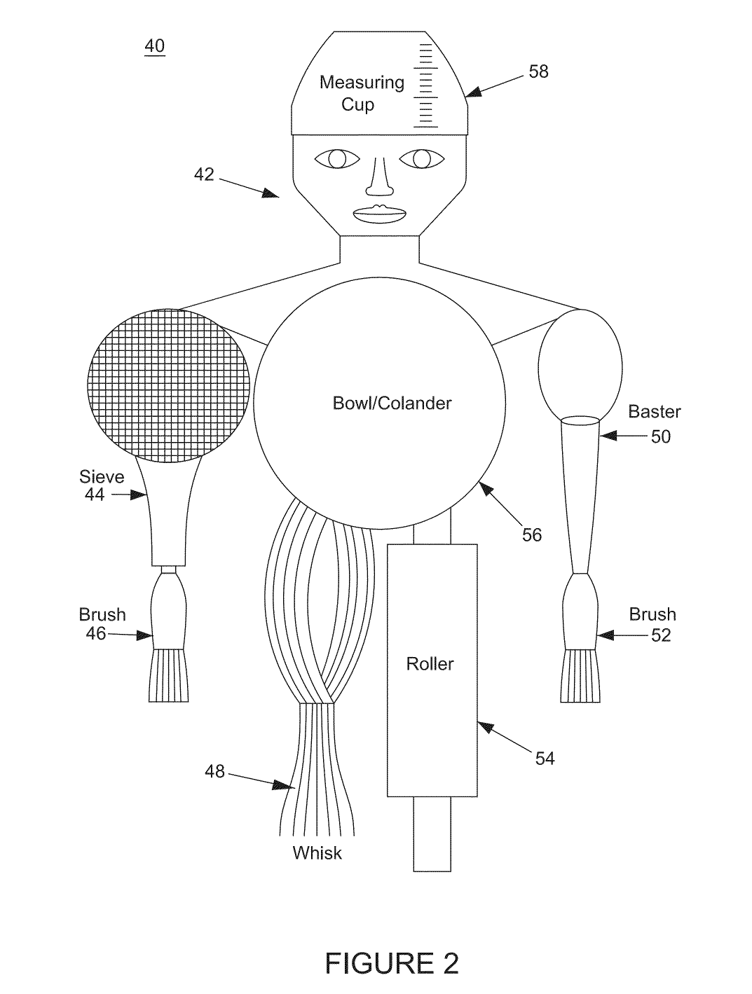

In an example embodiment, the culinary apparatus may be configured to resemble a person or the like, wherein appendages of the person comprise components. FIG. 2 is an illustration of an example culinary apparatus 40 configured to resemble a person having attachable and detachable appendages. As depicted in FIG. 2, the culinary apparatus 40 may comprise a skeletal dock 42 configured to resemble a frame of a person. And components 44, 46, 48, 50, 52, 54, 56 may form appendages of the person depicted by the culinary apparatus 40. For example, as depicted in FIG. 2, component 44 may comprise a sieve which may resemble a right arm of the depicted person. Component 46 may comprise a brush which may resemble a right hand of the depicted person. Component 50 may comprise a baster which may resemble a left arm of the depicted person. Component 52 may comprise a brush which may resemble a left hand of the depicted person. Component 48 may comprise a whisk which may resemble a right leg of the depicted person. Component 54 may comprise a roller which may resemble a left leg of the depicted person.

It is to be understood that the culinary apparatus depicted herein is merely an example, and that the configuration depicted therein is not to be limited thereto. Thus, although the culinary apparatus 12 may resemble a person, and the skeletal dock 14 of the culinary apparatus 12 may resemble a skeleton or frame of a person, the resemblance should not be limited thereto. The culinary apparatus may resemblance any appropriate item. Examples items may include a person, a specific person, a generic person, a male, a female, a character, an icon, an animal, a pet, an avatar, an inanimate item, a product, or the like, or any appropriate combination thereof. It is also to be understood that the number of components may vary, the nature of the components may vary, the configuration of the skeletal dock may vary, locations of sites at which components may be attached and/or detached may vary, and the configuration of sites may vary.

A component may depict a body part or adornment of the depicted person. For example, component 56 may comprise a bowl or colander which may resemble a torso of the depicted person. As another example, component 58 may comprise a measuring cup which may resemble a hat of the depicted person.

The culinary apparatus may comprise any appropriate material, such as, for example, plastic, metal, ceramic, rubber, a composite of materials, a bio gradable material, an edible material, or the like, or any appropriate combination thereof.

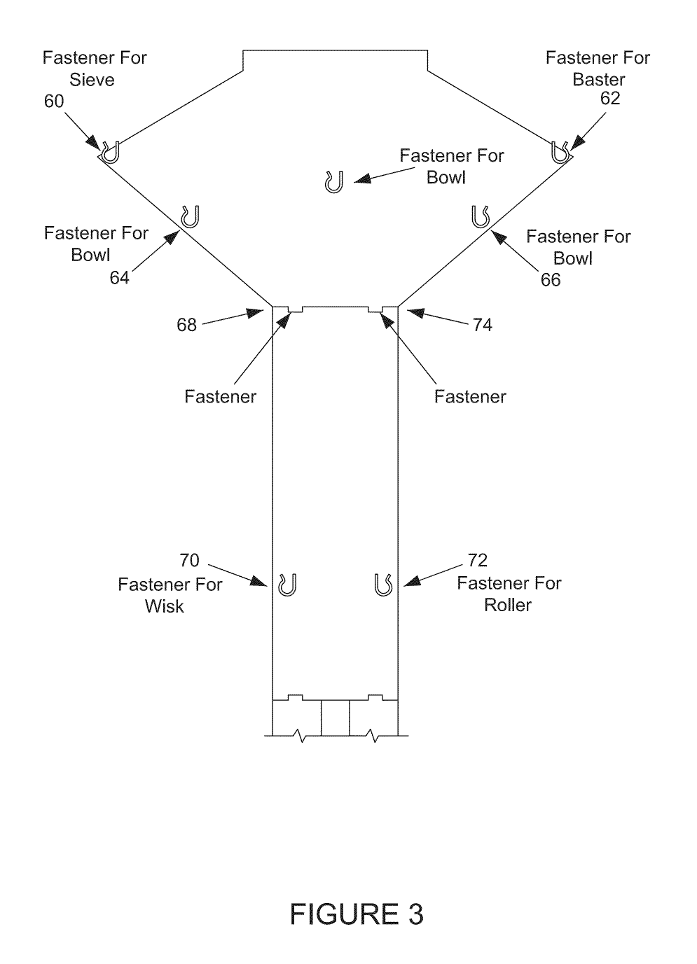

FIG. 3 is an example illustration of the skeletal dock of the culinary apparatus comprising example fasteners 60, 62, 64, 66, 68, 70, 72, 74. Fasteners may be utilized to attach a component to the culinary apparatus. A fastener may comprise any appropriate type of fastener. For example, a component may be attached to the culinary apparatus via any appropriate type of fastener, such as, a snap, a hook, hook and pile (e.g., VELCRO®), adhesive, an adhesive surface, a washable and renewable adhesive surface, a rivet, a clip, a screw, a nail, a bolt, a retaining ring, a pipe plug, a pin, a stud, an anchor, a nut (e.g., wind nut), a cap, a magnet, any appropriate combination thereof, or the like. In an example embodiment, a component may be placed on the skeletal dock of the culinary appliance, such as, for example, as shown in FIG. 2 for component 58 (e.g., measuring cup/hat).

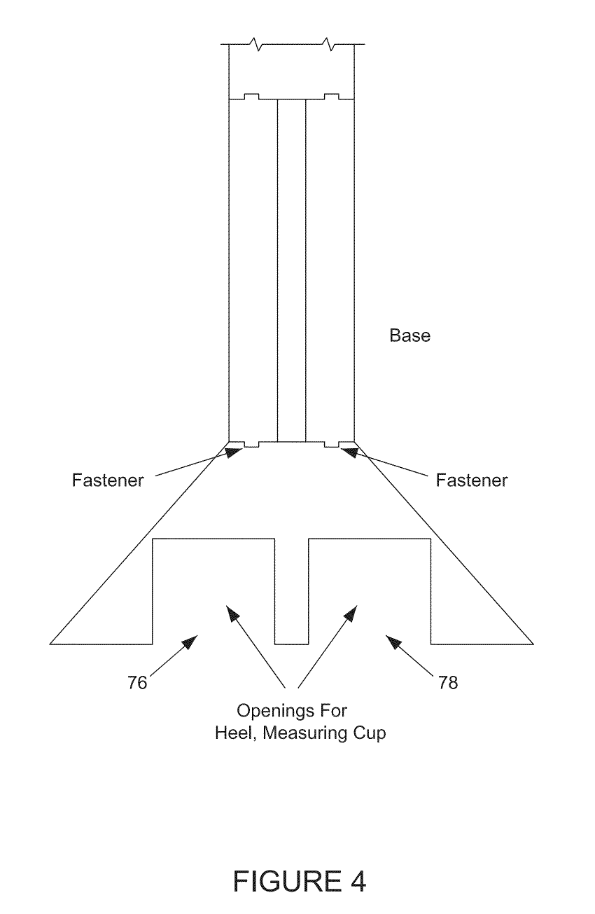

FIG. 4 is another example illustration of the skeletal dock of the culinary apparatus comprising locations 76, 78, for components located at the bottom of the skeletal dock. As depicted in FIG. 4, locations 76, 78, may be utilized to place components therein. For example a component resembling a foot may be positioned at location 76 and/or 78. A component resembling a foot may comprise any appropriate utensil, combination of utensils, or the like. In an example embodiment, a component resembling a foot may comprise a measuring cup, measuring cups, a spoon, or spoons.

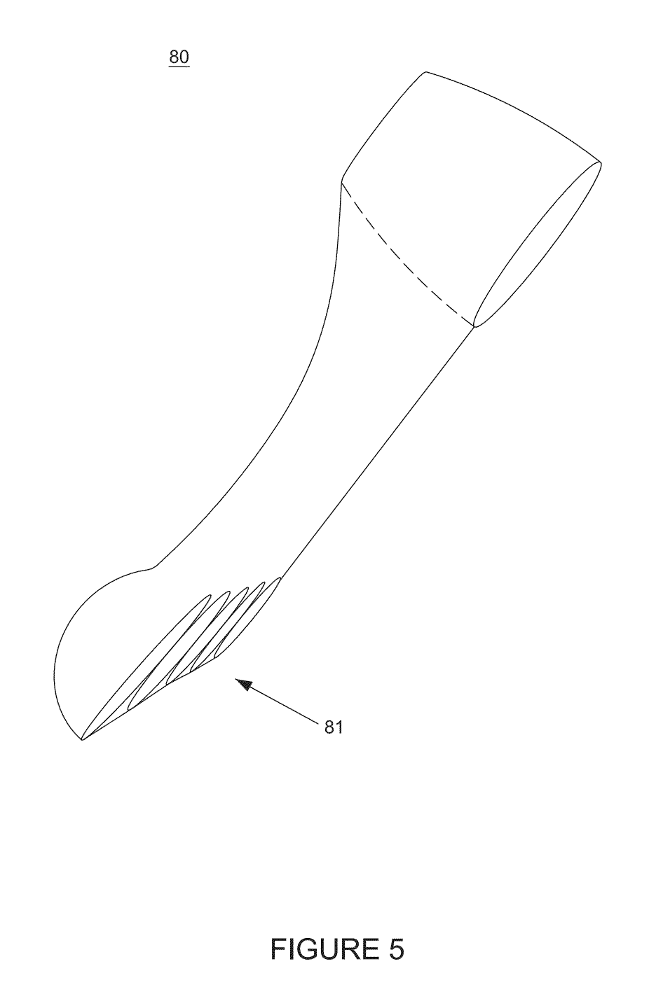

FIG. 5 is an illustration of an example component 80 resembling a foot comprising multiple measuring cavities 81. The component depicted in FIG. 5 may comprise any appropriate number of measuring cavities. The measuring capacity of a measuring cavity may comprise any appropriate measuring capacity. It is to be understood that any component may comprise a measuring cavity or measuring cavities. Thus, a component need not resemble a foot in order to comprise a measuring cavity. Therefore, any appropriate component, regardless of the nature of it resemblance to a body part, may comprise a measuring cavity or measuring cavities.

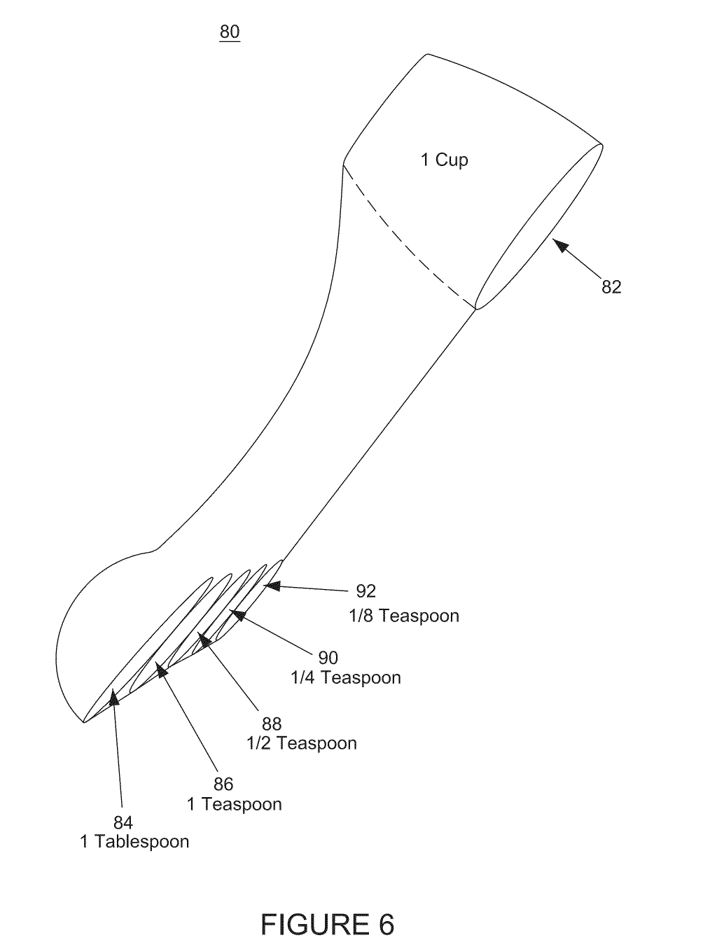

For example, FIG. 6 is a more detailed illustration of an example component 80 resembling a foot comprising multiple measuring cavities. As depicted in FIG. 6, cavity 82 may measure a quantity of 1 cup, cavity 84 may measure a quantity of one tablespoon, cavity 86 may measure a quantity of 1 teaspoon, cavity 88 may measure a quantity of one half of one teaspoon, cavity 90 may measure a quantity of one fourth of one teaspoon, and cavity 92 may measure a quantity of one eighth of one teaspoon.

It is to be understood that the measurement capacities as depicted in FIG. 6 are examples, and not to be limited thereto. Thus, amounts that may be measured by cavities may comprise any appropriate amounts. For example, in an example embodiment, cavity 84 may measure a quantity of ½ cup (e.g., 24 teaspoons, 8 tablespoons), cavity 86 may measure a quantity of ¼ cup (e.g., 12 teaspoons, 4 tablespoons), cavity 88 may measure a quantity of 1/8 cup (e.g., 6 teaspoons, 2 tablespoons), cavity 90 may measure a quantity of 1/16 cup (e.g., 3 teaspoons, 1 tablespoon), and cavity 92 may measure a quantity of 1/32 cup (e.g., 1½ teaspoons, ½ tablespoon).

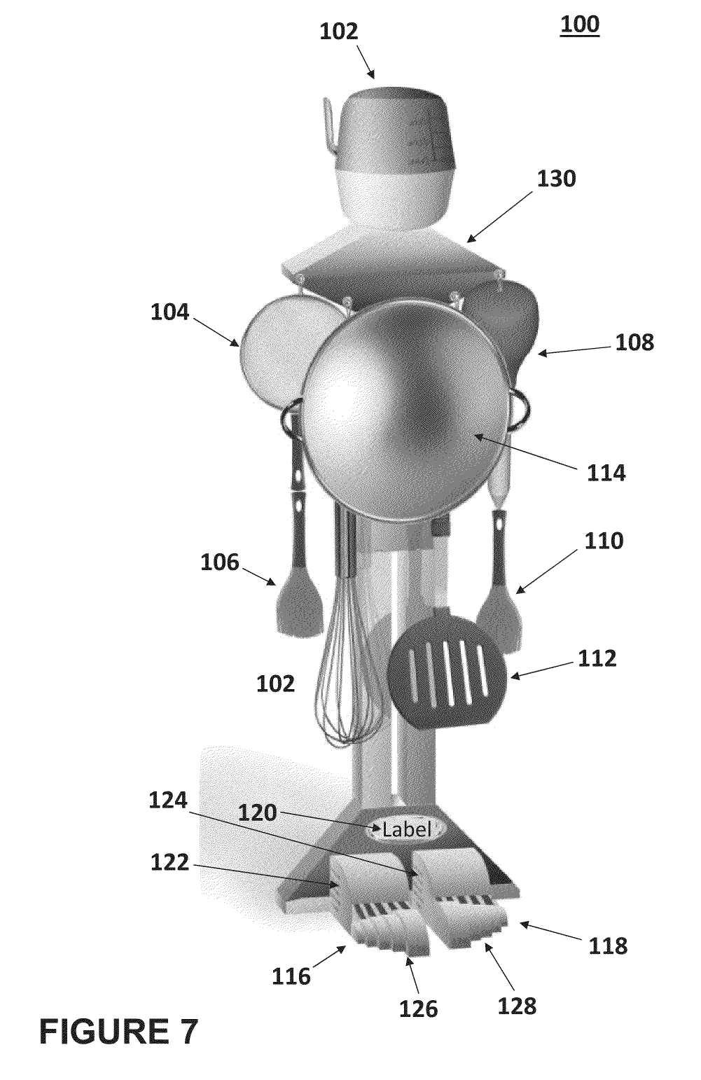

FIG. 7 is another example depiction of the culinary apparatus 100 as described herein. As depicted in FIG. 7, the culinary apparatus 100 may comprise a component 102 (measuring cup), component 104 (sieve/strainer), component 106 (a first type of spatula), component 108, (baster), component 110 (a second type of spatula), component 112 (a third type of spatula), component 114 (bowl), component 116 (measuring cups), and component 118 (measuring cups). Each component of the apparatus 100 may be attached and detached from a skeletal dock 130 of the apparatus 100 as described herein. The apparatus 100 may be marked and/or labeled in any appropriate manner. For example, as depicted in FIG. 7, a label 120 may indicate a source of the apparatus 100, a brand, a logo, a name of the apparatus (e.g., the name of the person using apparatus 100, if given as a gift, the name of the person to receive the gift, etc.), or the like, or any appropriate combination thereof. Also, components may be marked and/or labeled in any appropriate manner. For example, as depicted in FIG. 7, components 116 and 118 indicating measuring capacity may be marked to indicate respective capacities. A component may be marked on any appropriate surface of a component. As depicted in FIG. 7, components 116 and 118 may be marked on side surfaces 122, 124, and/or on front surfaces 126, 128 with an indication of measuring capacity. It is to be understood that the depiction of the apparatus 100 in FIG. 7 is exemplary, and not to be limited thereto. For example, the apparatus 100 may comprise any appropriate component, any appropriate number of components, components may be attached and/or detached in any appropriate manner, may be marked and/or labeled in any appropriate manner, may be marked and/or labeled on any appropriate surface, may be marked and/or labeled at any appropriate location, or the like.

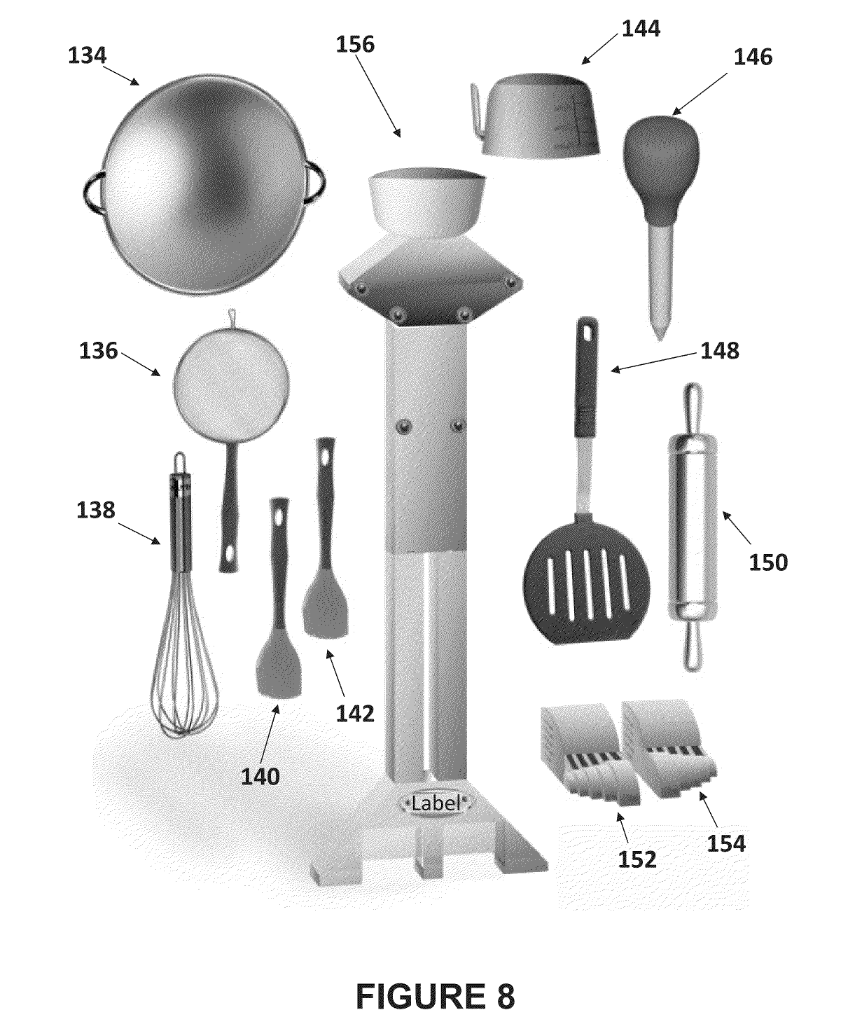

FIG. 8 is another example depiction of the culinary apparatus wherein components are detached. FIG. 8 depicts component 134 (bowl), component 136 (sieve, strainer), component 138 (whisk), component 140, (spatula), component 142 (spatula), component 144 (measuring cup), component 146 (baster), component 148 (spatula), component 150 (rolling pin), component 152 (measuring cups), component 154 (measuring cups), and skeletal dock 158. As described herein, each of components 134, 136, 138, 140, 142, 144, 146, 148, 150, 152, and 154 may be attached and detached from skeletal dock 158 without detrimentally affecting the use of any of components 134, 136, 138, 140, 142, 144, 146, 148, 150, 152, and 154.

While the culinary appliance has been described in connection with the various embodiments of the various figures, it is to be understood that other similar embodiments can be used or modifications and additions can be made to the described embodiments for implementing the culinary appliance without deviating therefrom. Therefore, the culinary appliance should not be limited to any single embodiment, but rather should be construed in breadth and scope in accordance with the appended claims.

What is claimed:

1. An apparatus comprising:
a skeletal docking portion, the skeletal docking portion comprising a plurality of component attachable and component detachable sites, wherein:
each site of the plurality of component attachable and component detachable sites is configured to attach to and detach from a respective component;
the apparatus resembles at least one of a person or an icon; and
the plurality of component attachable and component detachable sites are located proximate to appendages of the at least one of the resembled person or the resembled icon.

2. The apparatus of claim 1, wherein:
a component comprises a culinary appliance.

3. The apparatus of claim 1, further comprising:
a component attached to at least one of the plurality of component attachable and component detachable sites.

4. The apparatus of claim 1, wherein:
a component resembles an appendage of at least one of the resembled person or the resembled icon.

5. The apparatus of claim 1, wherein:
a component resembles an adornment of at least one of the resembled person or the resembled icon.

6. The apparatus of claim 1, wherein:
an appendage comprises another appendage.

7. The apparatus of claim 6, wherein the another appendage comprises at least one of a hand, an arm, a leg, a foot, or a torso.

8. The apparatus of claim 1, wherein a component comprises at least one of a culinary appliance comprising at least one of a bowl, a cup, a colander, a baster, a brush, a whisk, a roller, a rolling pin, a sieve, a spatula, a spoon, a knife, a fork, a dish, measuring jug, measuring cup, a measuring device, measuring spoon, a dispense, a corer, a cutter, a basket, a press, a lid, a jar, a pan, a pot, a tray, a butter curler, a block, a server, a scoop, a pitter, a strainer, a corkscrew, a cracker, scraper, a poacher, a timer, a sifter, a funnel, a grater, a ladle, a reamer, a juicer, a mandolin, a grinder, a thermometer, a melon baller, a mortar, a pestle, a tin, a pot holder, an oven glove, a bag, a blender, a masher, a mixer, a wheel, a peeler, a peel, a mill, a press (e.g., garlic press), shears, scissors, a scale, a scoop, a skimmer, a opener, tongs, or a zester.

9. The apparatus of claim 1, wherein each component attachable and detachable site of the plurality of component attachable and detachable sites comprises a respective fastener.

10. The apparatus of claim 9, wherein each respective fastener comprises at least one of a snap, a hook, hook and pile, an adhesive, an adhesive surface, a washable and renewable adhesive surface, a rivet, a clip, a screw, a nail, a bolt, a retaining ring, a pipe plug, a pin, a stud, an anchor, a nut, a cap, or a magnet.

11. A method comprising:
forming an apparatus comprising:
a skeletal docking portion, the skeletal docking portion comprising a plurality of component attachable and detachable sites, wherein:
each site of the plurality of component attachable and component detachable sites is configured to attach to and detach from a respective component;
the apparatus resembles at least one of a person or an icon; and
the plurality of component attachable and component detachable sites are located proximate to appendages of the at least one of the resembled person or the resembled icon.

12. The method of claim 11, wherein:
a component comprises a culinary appliance.

13. The method of claim 11, further comprising:
attaching a component to at least one of the plurality of component attachable and component detachable sites.

14. The method of claim 11, wherein:
a component resembles an appendage of at least one of the resembled person or the resembled icon.

15. The method of claim 11, wherein:
a component resembles an adornment of at least one of the resembled person or the resembled icon.

16. The method of claim 11, wherein:
an appendage comprises another appendage.

17. The method of claim 16, wherein the another appendage comprises at least one of a hand, an arm, a leg, a foot, or a torso.

18. The method of claim 11, wherein a component comprises at least one of a culinary appliance comprising at least one of a bowl, a cup, a colander, a baster, a brush, a whisk, a roller, a rolling pin, a sieve, a spatula, a spoon, a knife, a fork, a dish, measuring jug, measuring cup, a measuring device, measuring spoon, a dispense, a corer, a cutter, a basket, a press, a lid, a jar, a pan, a pot, a tray, a butter curler, a block, a server, a scoop, a pitter, a strainer, a corkscrew, a cracker, scraper, a poacher, a timer, a sifter, a funnel, a grater, a ladle, a reamer, a juicer, a mandolin, a grinder, a thermometer, a melon baller, a mortar, a pestle, a tin, a pot holder, an oven glove, a bag, a blender, a masher, a mixer, a wheel, a peeler, a peel, a mill, a press (e.g., garlic press), shears, scissors, a scale, a scoop, a skimmer, a opener, tongs, or a zester.

19. The method of claim 11, wherein each component attachable and detachable site of the plurality of component attachable and detachable sites comprises a respective fastener.

20. The method of claim 19, wherein each respective fastener comprises at least one of a snap, a hook, hook and pile, an adhesive, an adhesive surface, a washable and renewable adhesive surface, a rivet, a clip, a screw, a nail, a bolt, a retaining ring, a pipe plug, a pin, a stud, an anchor, a nut, a cap, or a magnet.
